(19) United States
(12) Patent Application Publication
(10) Pub. No.: US 2025/0076245 A1
(43) Pub. Date: Mar. 6, 2025

(54) METHOD AND SYSTEM FOR ESTABLISHING MODEL FOR SENSING IONS IN SOLUTION, AND METHOD AND SYSTEM FOR SENSING IONS IN SOLUTION

(71) Applicant: National Taiwan University, Taipei (TW)

(72) Inventors: Chih-Ting Lin, Taipei (TW); Yi-Ting Wu, Taipei (TW); Sheng-Yu Chen, Taipei (TW); Wei-En Hsu, Taipei (TW)

(21) Appl. No.: 18/505,995

(22) Filed: Nov. 9, 2023

(30) Foreign Application Priority Data
Aug. 30, 2023 (TW) 112132894

(51) Int. Cl. G01N 27/414

(52) U.S. Cl. CPC G01N 27/4146

(57) ABSTRACT

A method and system for establishing a model for sensing ions in a solution, and a method and system for sensing ions in a solution apply an ion-sensitive field effect transistor in a machine learning model for ion detection in training solutions. The method for establishing a model includes adjusting environmental parameters, where the environmental parameters are selected from any one of multiple target temperatures or from any one of multiple external electric fields; establishing at least one virtual sensor based on the biasing relationship of the multi-gate ion sensitive field effect transistor; obtaining, by the at least one virtual sensor, multiple training features of the training solution based on the environmental parameters and bias parameters; and loading, by a computer, the environmental parameters and the training features into a machine learning model to establish an ion detection model, which is used to sense the types and concentrations of ions.

### CROSS-REFERENCE TO RELATED APPLICATION

This non-provisional application claims priority under 35 U.S.C. § 119(a) to patent application No. 112132894 filed in Taiwan, R.O.C. on Aug. 30, 2023, the entire contents of which are hereby incorporated by reference.

### BACKGROUND

### Technical Field

The present disclosure relates to a method and system for machine learning, and a method and system for sensing, in particular to a method and system for establishing a model for sensing ions in a solution, and a method and system for sensing ions in a solution.

### Related Art

The increasing demand for telemedicine and environmental monitoring has accelerated the miniaturization of sensing devices. Wearable devices, for example, not only need to be lightweight, but also need to be able to sense a wearer's physical features or physiological signals. In addition, sensors may also be combined with the Internet of Things, so that sensors can monitor physiological features of the target object.

For the purpose of sensing multiple features, it is therefore necessary to provide different types of sensors in the prior art. However, different types of sensors have different volumes and power consumptions, and the integration of different sensors requires the processing of related signals. Therefore, the integration of different sensors will affect the overall volume and power consumption of the wearable device. Taking a sensing device for human physiological fluid as an example, since the physiological fluid is directly related to the physical features of the wearer, the physiological condition of the wearer may be determined based on various ions and concentrations thereof in the physiological fluid. Since detecting different ions requires corresponding sensors, this increases the volume of the integrated sensors and reduces the wearer's willingness to wear them.

Generally speaking, an ion-sensitive field-effect transistor (ISFET) is used in the sensor to recognize the ion types and concentrations of the solution. Because of the low sensitivity of the ISFET to most ions, it is difficult for the ISFET to produce enough changes in threshold voltage based on the ion types and concentrations. As a result, the ISFET has limited applicability.

### SUMMARY

In view of this, in some embodiments, a method for establishing a model for sensing ions in a solution, applying an ion-sensitive field-effect transistor (ISFET) in machine learning for ion detection in a training solution, is provided. The method for establishing a model for detecting ions in a solution includes: adjusting an environmental parameter, the environmental parameter being selected from any one of a plurality of target temperatures, any one of a plurality of external electric fields, any one of a plurality of external magnetic fields, or any one of a plurality of light intensities; establishing at least one virtual sensor based on a biasing relationship of the ISFET; obtaining, by the at least one virtual sensor, a plurality of training features of the training solution based on the environmental parameter and a bias parameter; loading, by a computer, the environmental parameter and the training features into a machine learning model to establish an ion detection model, the ion detection model being used to sense an ion type and an ion concentration. The method for establishing a model for detecting ions in a solution realizes different numbers of virtual sensors with a limited number of ISFETs, so as to obtain more samples of training features from the training solution. Different virtual sensors can capture corresponding training features for ion types or ion concentrations. The method for establishing a model for detecting ions in a solution can recognize ion types and concentrations without ion-selective membranes, which thereby can reduce the manufacturing cost and control the volume of the sensor.

In some embodiments, provided is a method for sensing ions in a solution, using an ISFET to sense an ion type and an ion concentration of a solution to be tested. The method for sensing ions in a solution includes: configuring the solution to be tested at the ISFET; driving, by the ISFET, a back gate pin of the ISFET based on a bias parameter to generate a virtual sensor; obtaining, by the virtual sensor, a feature to be verified corresponding to the solution to be tested; and receiving, by a computer, the feature to be verified, and loading the feature to be verified into an ion detection model to obtain the ion type and the ion concentration of the solution to be tested.

In some embodiments, provided is a system for establishing a model for sensing ions in a solution, applied in machine learning for ion detection in at least one training solution. The system for establishing a model for ions in a solution includes: a controller, configured to adjust an environmental parameter, the environmental parameter being selected from any one of a plurality of target temperatures, any one of a plurality of external electric fields, any one of a plurality of external magnetic fields, or any one of a plurality of light intensities; a virtual sensor, configured in the training solution, the virtual sensor obtaining a plurality of training features of the training solution based on the environmental parameter; and a computer, connected to the controller and the virtual sensor, the computer having a machine learning model, the computer loading the training features into the machine learning model to establish an ion detection model, and the ion detection model sensing an ion type and an ion concentration of each of the training solutions.

In some embodiments, provided is a system for sensing ions in a solution, configured to sense an ion type and an ion concentration of a solution to be tested. The system for sensing includes a controller, a sensor, and a computer. The controller is configured to adjust an environmental parameter of the solution to be tested. The environmental parameter is a target temperature or an external electric field. The sensor includes a first transmission interface and a field-effect transistor. The first transmission interface is configured to transmit a feature to be verified. The ISFET is electrically connected to the transmission interface. The solution to be tested is configured at a gate pin of the ISFET. The ISFET drives the gate pin based on a bias parameter to obtain the feature to be verified corresponding to the solution to be tested. The computer includes a storage unit, a second transmission interface, and a processing unit. The storage unit is configured to store an ion detection model. The second transmission interface is connected to the first transmission interface through signals and configured to transmit the feature to be verified. The processing unit is electrically connected to the storage unit and the second transmission interface. The processing unit loads the feature to be verified into the ion detection model to obtain the ion types and the ion concentration of the solution to be tested.

The method and system for establishing a model for sensing ions in a solution, and the method and system for sensing ions in a solution can realize a larger number of virtual sensors by means of a limited number of physical sensors, so that the volume of the physical sensors can be effectively reduced and the sensors can be applied to wearable devices or Internet of Things devices. Moreover, the virtual sensors obtain various recognition features of the solution to be tested (training solution) under different solution temperatures, current bias combinations, or other environmental conditions. The system for sensing ions in a solution can effectively recognize various ion types and ion concentrations in a solution of multiples ions.

### BRIEF DESCRIPTION OF THE DRAWINGS

FIG. 1 is a schematic diagram of a system for establishing a model for detecting ions in a solution according to an embodiment;

FIG. 2 is a schematic diagram of a sensor and an array of ISFETs according to an embodiment;

FIG. 3 is a schematic diagram of an ISFET according to an embodiment;

FIG. 4 is a schematic flowchart of a method for establishing a model for detecting ions in a solution according to an embodiment;

FIG. 5 is a schematic diagram of measurement results of a training solution under different target temperatures according to an embodiment;

FIG. 6A is a schematic diagram of measurement results under different external electric fields according to an embodiment;

FIG. 6B is a schematic diagram of measurement results under different external electric fields according to an embodiment;

FIG. 6C is a schematic diagram of measurement results under different external electric fields according to an embodiment;

FIG. 7 is a schematic diagram of a source current two-dimensional feature according to an embodiment;

FIG. 8A is a schematic diagram of corresponding source current two-dimensional features obtained under different back gate voltages according to an embodiment;

FIG. 8B is a schematic diagram of corresponding source current two-dimensional features obtained under different back gate voltages according to an embodiment;

FIG. 8C is a schematic diagram of corresponding source current two-dimensional features obtained under different back gate voltages according to an embodiment;

FIG. 9 is a schematic diagram of a system for sensing ions in a solution according to an embodiment;

FIG. 10 is a schematic flowchart of sensing ions in a solution according to an embodiment;

FIG. 11 is a schematic architecture diagram of a multilayer perceptron according to an embodiment;

FIG. 12 is a schematic architecture diagram of a convolutional neural network according to an embodiment;

FIG. 13 is a schematic three-dimensional diagram of concentrations of sodium ions, potassium ions and calcium ions according to an embodiment;

FIG. 14 is a schematic architecture diagram of a multilayer perceptron applied in another training solution according to an embodiment;

FIG. 15 is a schematic diagram of measurement of an ISFET under an external magnetic field according to an embodiment; and

FIG. 16 is a schematic diagram of measurement of an ISFET under light according to an embodiment.

### DETAILED DESCRIPTION

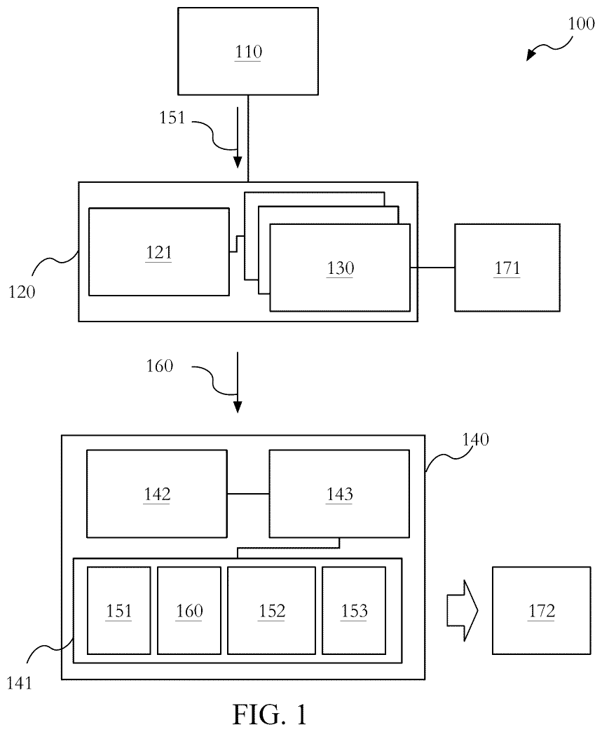

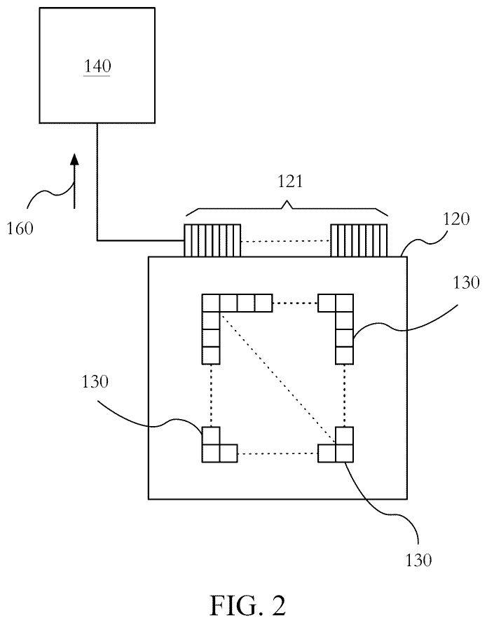

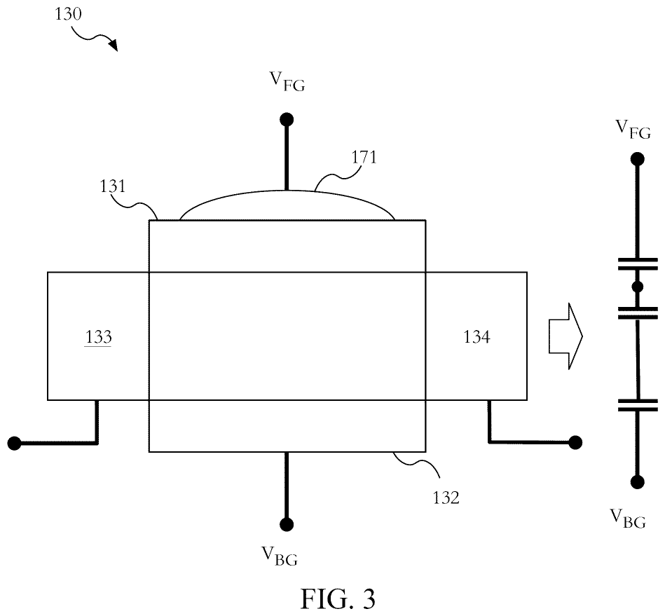

FIG. 1, FIG. 2, and FIG. 3 are respectively a schematic diagram of a system for establishing a model for detecting ions in a solution, a schematic diagram of a sensor and an array of ion-sensitive field-effect transistors (ISFETs), and a schematic diagram of an ISFET according to an embodiment. In this embodiment, learning for ion detection in a training solution 171 is mainly described. In other embodiments, ion sensing in a solution to be tested 921 is described.

A system for establishing a model for detecting ions in a solution (hereinafter referred to as a system 100) includes a controller 110, a sensor 120, and a computer 140. The computer 140 is electrically connected to the controller 110 and the sensor 120. The controller 110 may be arranged in the sensor 120 or outside the sensor 120. The controller 110 is configured to adjust an environmental parameter 151 of the training solution 171 or the sensor 120.

The sensor 120 includes a first transmission interface 121 and at least one ISFET. For the convenience of description, the following description is made in an example of a dual gate ISFET (DG-ISFET for short), and the DG-ISFET 130 structurally has a front gate pin 131 on the upper layer and a back gate pin 132 on the lower layer. However, the DG-ISFET 130 may also be any one of a fin FET, a nanowire FET, or a silicon-on-insulator FET.

One end of the first transmission interface 121 is electrically connected to the computer 140, and the other end of the first transmission interface 121 is connected to corresponding pins of the DG-ISFETs 130 to obtain training features 160. The corresponding pin is, for example, the back gate pin 132 or the front gate pin 131. The first transmission interface 121 transmits the training features 160 obtained by the DG-ISFET 130. The sensor 120 may be provided with at least one DG-ISFET 130 or an array of DG-ISFETs 130. For the arrangement of the array of DG-ISFETs 130, reference may be made to FIG. 2. For example, the array of DG-ISFETs 130 may be DG-ISFETs 130 arranged in an 32*32 array.

The left side of FIG. 3 is a side view of the DG-ISFET 130. The front gate pin 131 of the DG-ISFET 130 is configured in the training solution 171. A source pin 133 and a drain pin 134 are respectively on two sides of the DG-ISFET 130. In an example of any DG-ISFET 130 in FIG. 2, the upper side surface of the DG-ISFET 130 in FIG. 2 corresponds to the side of the front gate pin 131 of the DG-ISFET 130 in FIG. 3.

The controller 110 may be optionally arranged at the front gate pin 131 or the back gate pin 132 based on the environmental parameter 151. The type of the environmental parameter 151 may be, but not limited to, any one of a target temperature, an external electric field, an external magnetic field, or a light intensity. If the environmental parameter 151 is the target temperature, the controller 110 may be arranged on a side surface of the front gate pin 131. Alternatively, the controller 110 is arranged on an intersecting side of two adjacent DG-ISFETs 130, and the controllers 110 on all sides form a tic-tac-toe grid shape. The controller 110 is configured to directly adjust a temperature of the training solution 171. If the environmental parameter 151 is the external electric field, the controller 110 is connected to the back gate pin 132 and controls the external electric field, so as to apply a bias intensity to the back gate pin 132.

When a bias is applied to the back gate pin 132 of the DG-ISFET 130, a current channel is formed above an oxide layer of a back gate of the DG-ISFET 130. When a bias is applied to both the front gate pin and the back gate pin 132 of the DG-ISFET 130, due to the asymmetry between a front gate oxide layer capacitance (Cₜₒₓ) and a back gate oxide layer capacitance (C_{box}), signal amplification is realized, as shown in FIG. 3. The right side of FIG. 3 is an equivalent circuit of the DG-ISFET 130. An amplification relation of the DG-ISFET 130 is as follows:

$$\frac{Δ {V}_{BG}}{{Δ}_{{p}_{H}}} = \frac{Δ {V}_{{FG}^{′}}}{{Δ}_{{p}_{H}}} \times ( \frac{{C}_{tox}}{{C}_{box}} ) \times {α}_{SN}$$

where (Cₜₒₓ/C_{box}) is a signal amplification ratio, and α_{SN} is regarded as a constant in the same operation region.

During the measurement of the DG-ISFET 130 for a drain current versus front gate voltage transfer curve 161 (I_{D}−V_{FG}), under the action of different back gate voltages V_{BG} (or back gate biases), the DG-ISFET 130 generates a front gate voltage V_{FG} with corresponding intensity, thereby causing a shift of the transfer curve. Therefore, a corresponding number of virtual sensors 120 are established based on a set of bias parameters of the back gates of the DG-ISFETs 130 (this set is collectively referred to as a biasing relationship 153).

The computer 140 has a storage unit 141, a second transmission interface 142, and a processing unit 143. The processing unit 143 is electrically connected to the storage unit 141 and the second transmission interface 142. The storage unit 141 is configured to store the environmental parameters 151, the training features 160, a machine learning model 152, and the biasing relationship 153. The second transmission interface 142 is connected to the first transmission interface 121 through signals. The processing unit 143 receives the training features 160 through the second transmission interface 142. The training feature 160 includes the drain current versus front gate voltage transfer curve 161 (I_{D}−V_{FG}), a source current 162, a source current two-dimensional feature 163, or a combination thereof. The processing unit 143 executes the machine learning model 152 based on the training features 160.

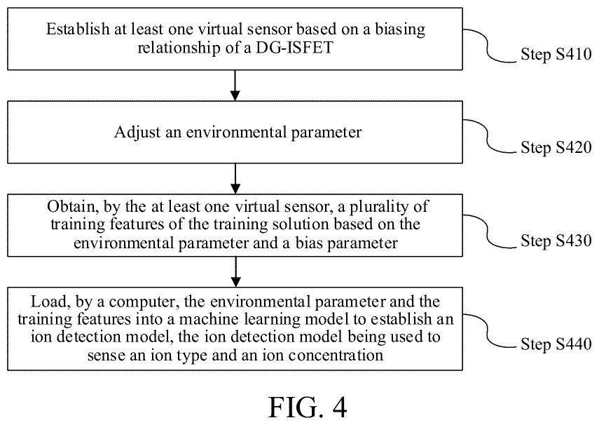

A process of machine learning in the training solution 171 by the system 100 will be further described with reference to FIG. 4. A machine learning method of the system 100 includes the following steps:

Step S410: Establish at least one virtual sensor based on a biasing relationship of a DG-ISFET.

Step S420: Adjust an environmental parameter.

Step S430: Obtain, by the at least one virtual sensor, a plurality of training features of the training solution based on the environmental parameter and a bias parameter, the biasing relationship including a plurality of bias parameters.

Step S440: Load, by a computer, the environmental parameter and the training features into a machine learning model to establish an ion detection model, the ion detection model being used to sense an ion type and an ion concentration.

First, the training solution 171 is prepared. The training solution 171 may be a solution of a single ion or multiple ions. The training solution 171 is configured at a front gate pin 131 of the DG-ISFET 130. The DG-ISFET 130 respectively establishes a corresponding number of virtual sensors 120 based on different biasing relationships 153. The DG-ISFET 130 may obtain corresponding front gate voltages V_{FG} by controlling back gate biases of different back gate pins 132 under the condition of the same training solution 171 (corresponding to step S410). Then, the training solution 171 is configured at the front gate pin 131 of the DG-ISFET 130. Generally speaking, the same training solution 171 may be configured for an array of DG-ISFETs 130, so that various virtual sensors 120 in the DG-ISFETs 130 can obtain respective training features 160.

Next, the environmental parameter 151 of the DG-ISFET 130 or the environmental parameter 151 of the training solution 171 is set (corresponding to step S420). The type of the environmental parameter 151 may be a target temperature, an external electric field, an external magnetic field, or a light intensity. The target temperature is a set of multiple temperatures. The external electric field is a general name of a set of multiple biases. The external magnetic field is a general name of a set of multiple magnetic fields. The light intensity is a general name of different intensities of light.

Due to the low sensitivity of the ISFET to most ions, the threshold voltage change caused by the ion types and concentrations is too small to produce an enough slope change as a feature. In order to solve the problem of too small threshold voltage change, the adjustment of the environmental parameter 151 is added to the system 100, which causes non-ideal effects on both the sensing membrane/solution interface and the transistor, and further causes additional nonlinear changes in the threshold voltage and the ion mobility. The computer 140 obtains corresponding information based on the aforementioned nonlinear changes, and regards the obtained information as the training features 160.

The computer 140 may set the controller 110 based on the selected environmental parameter 151. After the setting of the environmental parameter 151 of the controller 110 is completed, corresponding biases are sequentially applied to the back gate pins 132 based on the bias parameters to drive the corresponding virtual sensor 120 to obtain the training features 160 (corresponding to step S430). The computer 140 receives measurement data obtained by the virtual sensors 120. For simplicity of description, raw data measured by the virtual sensors 120 is also called the training feature 160. After the computer 140 obtains all the training features 160 of the training solution 171, the computer 140 loads the training features 160 into the machine learning model 152 to generate an ion detection model 172 (corresponding to step S440). The computer 140 stores the ion detection model 172 into the storage unit 141.

In order to distinguish time points when different virtual sensors 120 obtain training features 160, the system 100 will operate based on different epochs. In each epoch, a specific virtual sensor 120 is selected to obtain the training features 160. The currently operating virtual sensor 120 is regarded as being in the current epoch, and the next operating virtual sensor 120 is regarded as being in the next epoch.

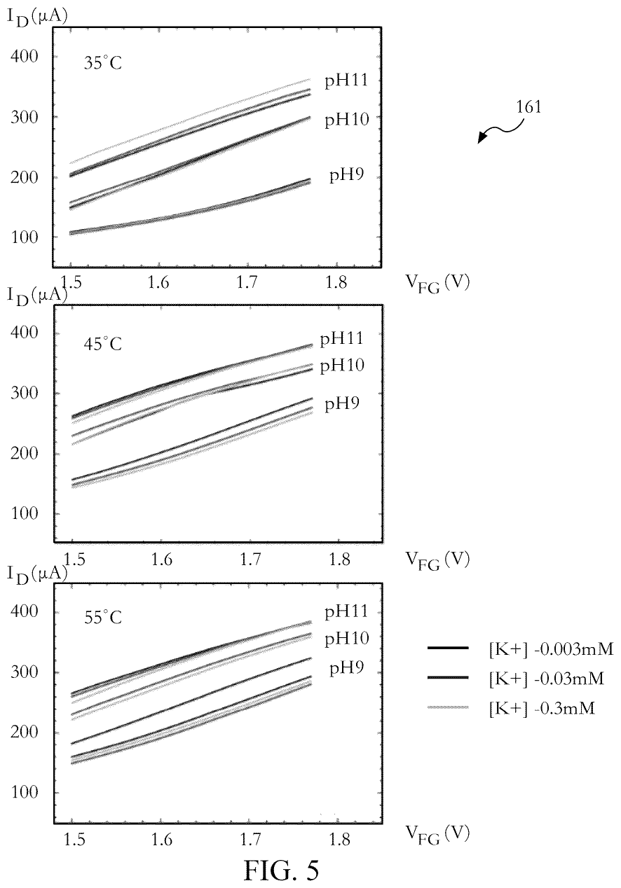

In some embodiments, at the end of each epoch, the computer 140 selects one of the remaining target temperatures as a new environmental parameter 151. The computer 140 drives the controller 110 to adjust a temperature of the training solution 171, so that the next virtual sensor 120 obtains the training features 160 under the new environmental parameter 151. For example, the virtual sensor 120 of the next epoch obtains the corresponding drain current versus front gate voltage transfer curve 161 (I_{D}−V_{FG}, i.e., training feature 160) under the new temperature. FIG. 5 shows measurement results of the drain current versus front gate voltage transfer curve 161 of the training solution 171 under different target temperatures. The computer 140 continues to drive the controller 110 to select a new target temperature (i.e., new environmental parameter 151) and enable the virtual sensor 120 to obtain the training feature 160 under the new temperature. This process is repeated until all the target temperatures have been selected and utilized once (corresponding to step S430).

In some embodiments, the computer 140 further includes a standardization program (not marked). After the virtual sensor 120 obtains the training features 160, the computer 140 performs a standardization program on all the training features 160 to generate standardized training features 160. The standardization program 194 may be, but not limited to, Z-Score.

For the DG-ISFET 130, adjusting the temperature of the training solution 171 may affect the detecting membrane/solution interface and the DG-ISFET 130. In other words, changing the temperature of the training solution 171 may change the nonlinear change of the transfer curve. The relationship between a dipole potential (Xₛₒₗ) and the temperature of the solid-liquid interface of the sensing membrane/solution interface is as follows:

Xₛₒₗ=0.051[1−exp(0.86 log Iₒₛ)]×[1−0.008(T−298.16)]
where Iₒₓ is the ionic strength controlled by the ion concentration in the solution;

and T is the temperature.

As can be seen from the above formula, the temperature of the solution may affect the electron mobility in the channel, and thus change the characteristics of the channel. When the back gate voltage V_{BG} is low, the transfer characteristic curve of the DG-ISFET 130 is dominated by the threshold voltage. When the back gate voltage V_{BG} is high, the transfer characteristic curve is dominated by the electron mobility. For the DG-ISFET 130, the change in the threshold voltage is very important, so the operation is controlled within the region where the back gate voltage V_{BG} is low. FIG. 5 shows drain current versus front gate voltage transfer curves 161 (I_{D}−V_{FG}) measured in the training solutions 171 with different ion types and concentrations at 3 target temperatures (35° C., 45° C., and 55° C. respectively).

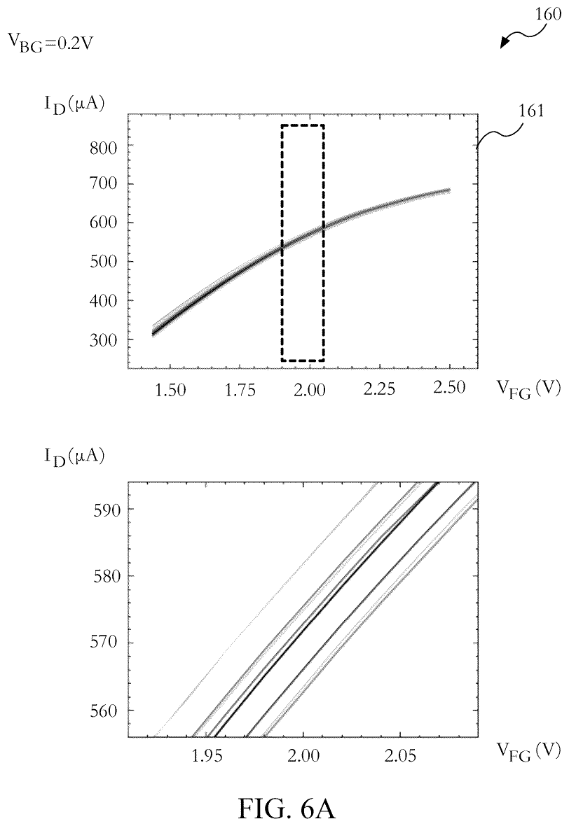

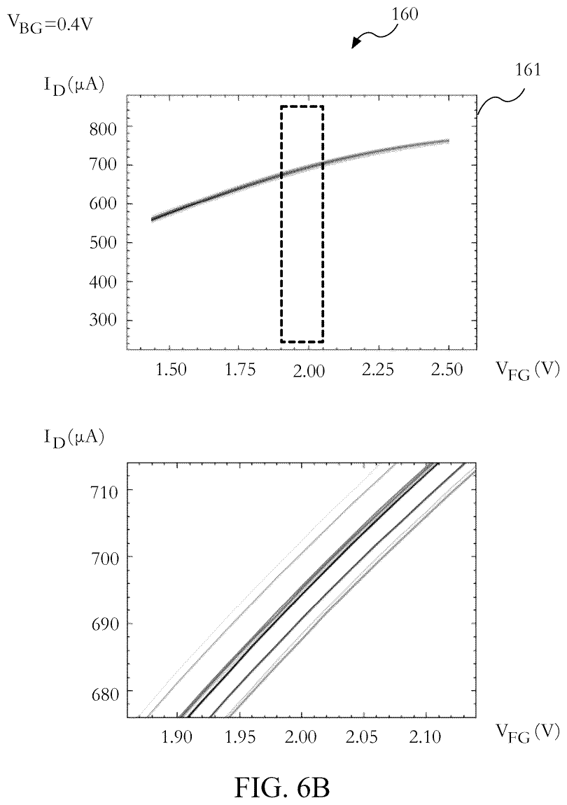

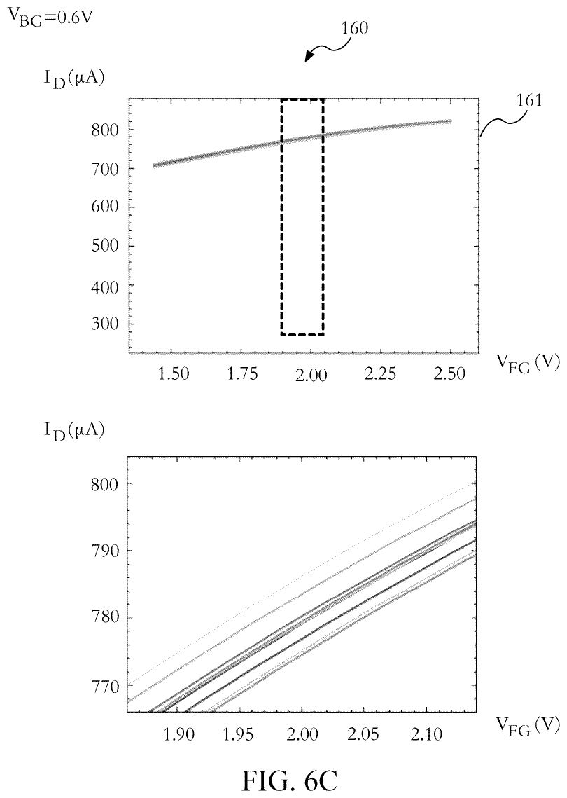

In some embodiments, after the computer 140 obtains the training feature 160 of the current epoch, the computer 140 selects a new external electric field from the remaining external electric fields, and takes the selected external electric field as a new environmental parameter 151. The controller 110 may control the bias of the back gate pin 132 of the DG-ISFET 130, thereby changing the external electric field of the DG-ISFET 130. The computer 140 drives the controller 110 such that the controller 110 adjusts the electric field intensity of the DG-ISFET 130 based on the new environmental parameter 151 to obtain the corresponding drain current versus front gate voltage transfer curve 161 (i.e., training feature 160), as shown in FIG. 6A, FIG. 6B, and FIG. 6C. The computer 140 drives the controller 110 to select a new environmental parameter 151 from the remaining external electric fields and obtain the corresponding training feature 160 until all the external electric fields are completed (corresponding to step S430). Since under different back gate voltages V_{BG}, changing the front gate voltage V_{FG} of the DG-ISFET 130 can obtain transfer characteristic curve data of different operation regions, the transfer characteristic curve may be regarded as the training feature 160 obtained by the virtual sensor 120.

The upper sides of FIG. 6A, FIG. 6B, and FIG. 6C show the drain current versus front gate voltage transfer curves 161 (I_{D}−V_{FG}) corresponding to different back gate voltages V_{BG}. FIG. 6A, FIG. 6B, and FIG. 6C show drain current versus front gate voltage V_{FG} measurement records of 9 training solutions 171 under back gate voltages (V_{BG}) of 0.2 V. 0.4 V. and 0.6 V. As can be seen from the upper sides of FIG. 6A, FIG. 6B, and FIG. 6C, the transfer characteristic curves of the training solutions 171 with different compositions do not shift with the ion concentration. The lower sides of FIG. 6A, FIG. 6B, and FIG. 6C show partial enlarged curves. The partial enlarged parts are dashed boxes on the upper sides of FIG. 6A, FIG. 6B, and FIG. 6C.

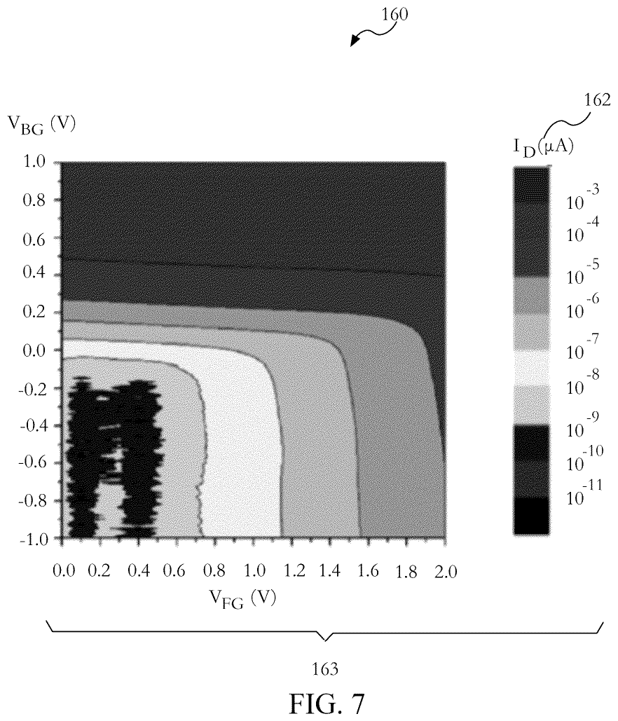

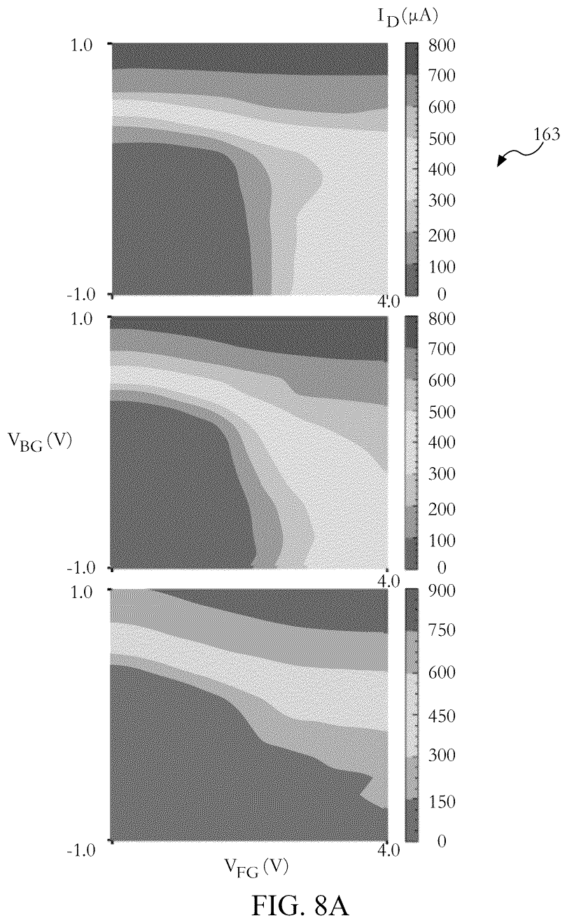

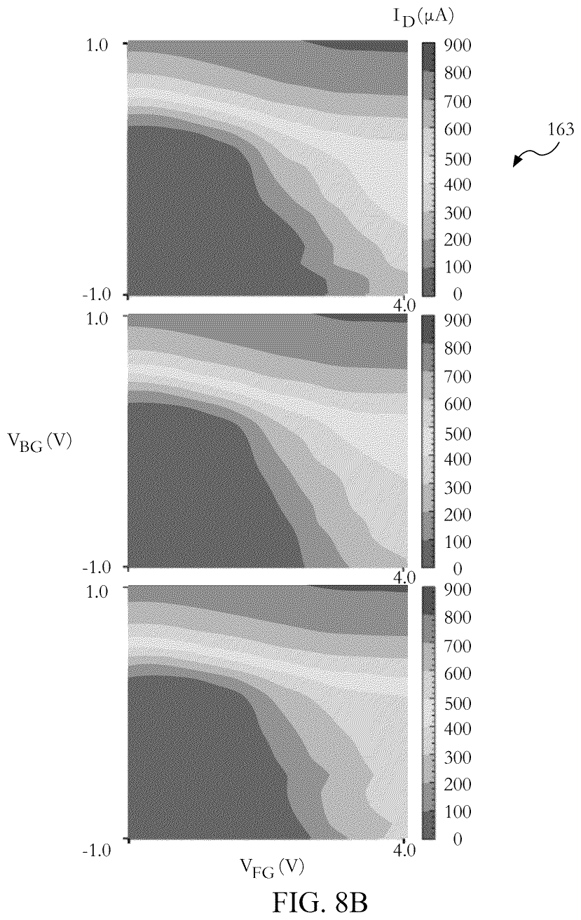

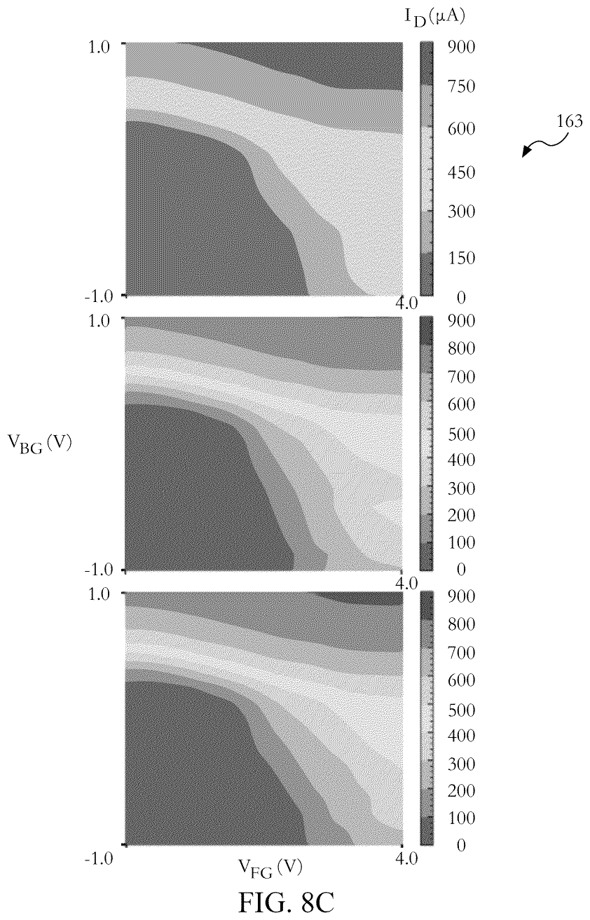

In some embodiments, after the computer 140 selects a new external electric field, the computer 140 drives the controller 110 such that the controller 110 obtains the source current two-dimensional feature 163 (i.e., training feature 160). The source current two-dimensional feature 163 includes a relationship between the source current 162 (I_{ds}), the front gate voltage V_{FG} and the back gate voltage V_{BG}, as shown in FIG. 7. The left side of FIG. 7 shows a two-dimensional feature diagram of the front gate voltage V_{FG} and the back gate voltage V_{BG}, and the right side of FIG. 7 shows the source current 162. The computer 140 takes different source current two-dimensional features 163 as the training feature 160 (corresponding to step S430). FIG. 8A, FIG. 8B, and FIG. 8C show the corresponding source current two-dimensional features 163 obtained under different back gate voltages V_{BG}. The training process of the training solutions 171 in FIG. 8A to FIG. 8C and the corresponding source current two-dimensional features 163 will be explained later.

In some embodiments, the computer 140 further includes a principal component analysis (PCA) program (not marked). When the computer 140 loads the environmental parameter 151 and the training features 160 into the machine learning model 152, the computer 140 selects part of the source current two-dimensional features 163 from the set of source current two-dimensional features 163, for example, 15% of the training features 160. The computer 140 loads selected source current two-dimensional feature 163 into the PCA program to obtain a compressed feature. The computer 140 removes the redundant training features 160 to reduce the amount of calculation when training the ion detection model 172. Next, the computer 140 loads the compressed feature and the environmental parameter 151 into the machine learning model 152 to establish the ion detection model 172.

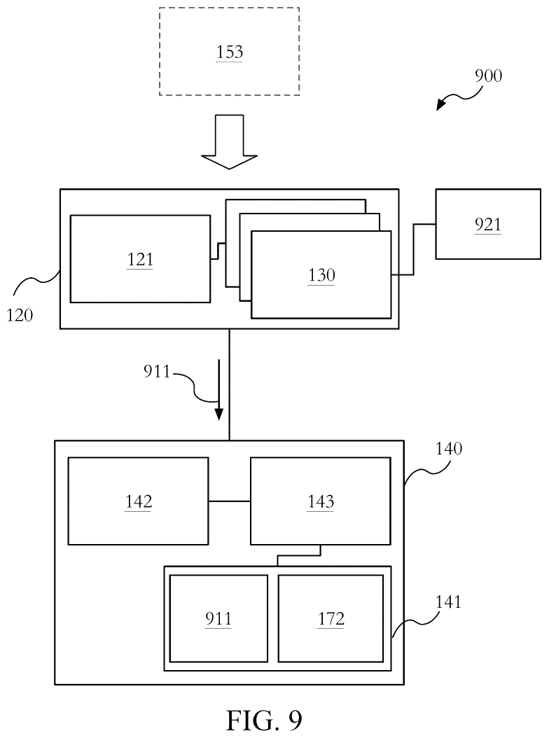

In some embodiments, a system 900 for sensing ions in a solution (system 900 for short) includes a sensor 120 and a computer 140, as shown in FIG. 9. The computer 140 is electrically connected to the sensor 120. The sensor 120 includes a first transmission interface 121 and at least one ISFET. In this embodiment, the ISFET is still described in an example of the DG-ISFET 130, and for its structure, reference may be made to FIG. 3. One end of the first transmission interface 121 is electrically connected to the computer 140, and the other end of the first transmission interface 121 is connected to corresponding pins of the DG-ISFETs 130. The first transmission interface 121 transmits the training features 160 obtained by the DG-ISFET 130.

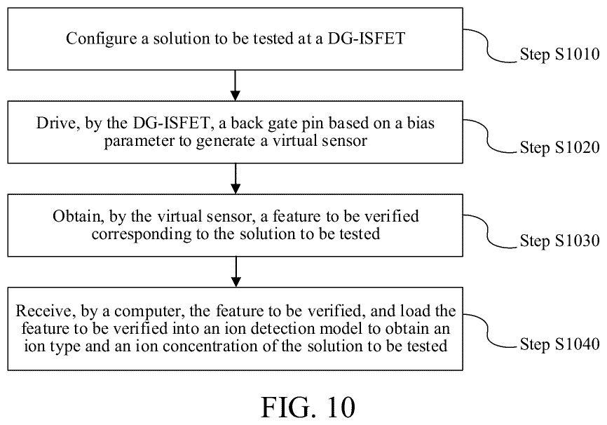

The computer 140 has a storage unit 141, a second transmission interface 142, and a processing unit 143. The processing unit 143 is electrically connected to the storage unit 141 and the second transmission interface 142. The storage unit 141 is configured to store the environmental parameters 151, the features to be verified, and the ion detection model 172. The second transmission interface 142 is connected to the first transmission interface 121 through signals. The processing unit 143 receives the features to be verified through the second transmission interface 142. A process of machine learning in the training solution 171 by the system 100 will be further described with reference to FIG. 10. The method of the system 900 includes the following steps:

Step S1010: Configure the solution to be tested at the DG-ISFET.

Step S1020: Drive, by the DG-ISFET, a back gate pin based on a bias parameter to generate a virtual sensor.

Step S1030: Obtain, by the virtual sensor, a feature to be verified corresponding to the solution to be tested.

Step S1040: Receive, by a computer, the feature to be verified, and load the feature to be verified into an ion detection model to obtain the ion type and the ion concentration of the solution to be tested.

First, the solution to be tested 921 is configured at the DG-ISFET 130, so that the front gate pin 131 of the DG-ISFET 130 contacts the solution to be tested 921. The solution to be tested 921 has unknown ion types and concentrations. Biases are sequentially applied to the DG-ISFET 130 to generate different virtual sensors 120 and obtain corresponding features to be verified. Next, the processing unit 143 obtains the features to be verified of the virtual sensors 120 through the second transmission interface 142 and the first transmission interface 121. The processing unit 143 loads the features to be verified into the ion detection model 172 to obtain the ion type and the ion concentration of the solution to be tested 921.

In some embodiments, the type of the machine learning model 152 may be, but not limited to, a multilayer perceptron (MLP), a convolutional neural network (CNN 514), or a combination thereof. Based on different training features 160, the computer 140 selects the corresponding machine learning model 152 and loads the training features 160 into the machine learning model 152. The training of the machine learning model 152 based on the corresponding training features 160 under different environmental parameters 151 will be described below. The ion types and concentrations of the training solutions 171 are not limited to the following examples.

In some embodiments, sodium hydroxide (NaOH) and potassium chloride (KCl) in different proportions are dissolved in deionized water to generate mixed solutions of hydrogen ions (pH) and potassium ions (pK). Sodium hydroxide is used to prepare training solutions 171 with hydrogen ion concentrations of 1×10⁻⁹ M, 1×10⁻¹⁰ M, and 1×10⁻¹¹ M, which are respectively denoted as pH 9, pH 10, and pH 11. Potassium chloride is used to prepare training solutions 171 with potassium ion concentrations of 3×10⁻⁴ M, 3×10⁻⁵ M, and 3×10⁻⁶ M, which are respectively denoted as pK 3.5, pK 4.5, and pK 5.5. Based on different concentrations of the two ions, 9 training solutions 171 with different ion types and concentrations (in Table 1, the training solutions 171 are numbered as follows: solution 1, solution 2, solution 3, solution 4, solution 5, solution 6, solution 7, solution 8 and solution 9) may be prepared, as shown in the following table:

TABLE 1
Compositions of mixed solutions of
hydrogen ions and potassium ions

| | [H+] M | pH | [K+] M | pK |
|---|---|---|---|---|
| Solution 1 | 1 × 10−9 | 9 | 3 × 10−6 | 5.5 |
| Solution 2 | | | 3 × 10−5 | 4.5 |
| Solution 3 | | | 3 × 10−4 | 3.5 |
| Solution 4 | 1 × 10−10 | 10 | 3 × 10−6 | 5.5 |
| Solution 5 | | | 3 × 10−5 | 4.5 |
| Solution 6 | | | 3 × 10−4 | 3.5 |
| Solution 7 | 1 × 10−11 | 11 | 3 × 10−6 | 5.5 |
| Solution 8 | | | 3 × 10−5 | 4.5 |
| Solution 9 | | | 3 × 10−4 | 3.5 |

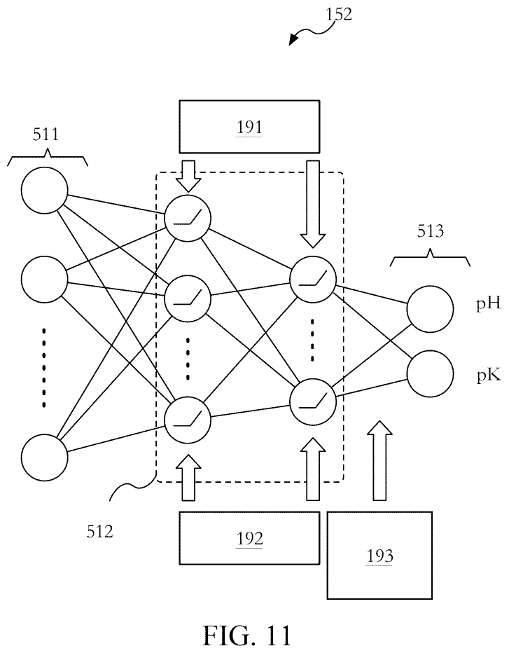

The training solution 171 is configured on the sensor 120, and the controller 110 is driven to adjust the temperature of the solution to 35° C., 45° C., and 55° C., as shown in FIG. 5. Under each target temperature, the training feature 160 of the training solution 171 is measured by the same sensor 120. The training feature 160 is the drain current versus front gate voltage transfer curve 161 (I_{D}−V_{FG}). The computer 140 obtains the training features 160 of all the training solutions 171 under different target temperatures and different biases. The computer 140 selects the MLP as the machine learning model 152, with reference to FIG. 11. After obtaining the training features 160, the computer 140 may select part of the training features 160. The selected training features 160 are features to be verified for the ion detection model 172. It is assumed that 85% of the total number of the collected training features 160 is taken as the number of samples for training the machine learning model 152, and 30% is further selected from the set of training samples as samples for verification. The samples for verification are not used for model training. Instead, the samples for verification are loaded into the ion detection model 172 for evaluate the model after the completion of the training epochs. The remaining 15% of the training features 160 may be regarded as the features to be verified for testing the ion detection model 172.

The MLP is of a multilayer neural structure, which has an input layer 511, a hidden layer 512, and an output layer 513. The input layer 511 has 30 neurons, respectively representing 10 features of three groups of temperature conditions under each temperature condition. The MLP in FIG. 11 has 2 hidden layers 512. The first hidden layer 512 has 20 neurons, which is determined by 2/3 of the number of the upper layer. The second hidden layer 512 has 13 neurons. Each neuron of the hidden layer 512 uses a rectified linear unit (ReLU) as the activation function. The output layer 513 has two neurons, corresponding to the two ion types and concentrations (corresponding to pH ion and pK ion).

In some embodiments, mechanisms such as batch normalization 191, L2 regularization 192, and random dropout of neurons 193 may be added to the hidden layer 512 in the MLP to improve the generalization ability of the MLP, thereby avoiding overfitting. In addition, in the process of training the MLP, an Adam optimization algorithm may be used for an optimizer back propagation to update the learning rate and add momentum. For the loss function, a mean absolute percentage error (MAPE) is used, and the training result of the MLP is evaluated by the output percentage result. The MAPE is calculated by the following formula:

$$MAPE = \frac{1}{N} {\sum }_{t = 1}^{N} \vert \frac{{observed}_{t} - {predicted}_{t}}{{observed}_{t}} \vert \times 10 \; 0 .$$

The computer 140 establishes the corresponding ion detection model 172 based on the MLP and the training features 160. The computer 140 loads the features to be verified to the ion detection model 172 to evaluate the sensing ability of the ion detection model 172. The table below shows a list of sensing the ion detection model 172 with the features to be verified. The table records the ground truth (GT), the prediction result mean (Mean) and the MAPE corresponding to the features to be verified.

TABLE 2
Statistics of results of temperature sensing model

| | pH | | | pK | | |
|---|---|---|---|---|---|---|
| | GT | Mean | MAPE (%) | GT | Mean | MAPE (%) |
| Solution 1 | 9 | 9.003 | 0.032 | 5.5 | 5.336 | 3.381 |
| Solution 2 | | 9.009 | 0.101 | 4.5 | 4.526 | 0.068 |
| Solution 3 | | 9.013 | 0.150 | 3.5 | 3.531 | 0.222 |
| Solution 4 | 10 | 9.907 | 0.929 | 5.5 | 5.380 | 2.587 |
| Solution 5 | | 9.897 | 1.031 | 4.5 | 4.484 | 0.851 |
| Solution 6 | | 9.897 | 1.026 | 3.5 | 3.539 | 0.452 |
| Solution 7 | 11 | 10.856 | 1.305 | 5.5 | 5.424 | 1.797 |
| Solution 8 | | 10.872 | 1.161 | 4.5 | 4.349 | 3.841 |
| Solution 9 | | 10.890 | 0.996 | 3.5 | 3.534 | 0.319 |

In some embodiments, for example, training solutions 171 of sodium chloride (NaCl) and potassium chloride (KCl) are prepared when the environmental parameter 151 is an external electric field. First, sodium chloride is used to respectively prepare the training solutions 171 with sodium ion (pNa) concentrations of 3×10⁻⁴ M, 3×10⁻⁵ M, and 3×10⁻⁶ M, which are respectively denoted as pNa 3.5, pNa 4.5, and pNa 5.5. Potassium chloride is used to prepare the training solutions 171 with potassium ion concentrations of 3×10⁻⁴ M, 3×10⁻⁵ M, and 3×10⁻⁶ M, which are respectively denoted as pK 3.5, pK 4.5, and pK 5.5. 9 different training solutions 171 may be prepared based on the concentrations of the two ions, as shown in the following table:

TABLE 3
Compositions of mixed solutions of sodium ion and potassium ion

| | [Na+] M | pNa | [K+] M | pK |
|---|---|---|---|---|
| Solution 1 | 3 × 10−4 | 3.5 | 3 × 10−4 | 3.5 |
| Solution 2 | | | 3 × 10−5 | 4.5 |
| Solution 3 | | | 3 × 10−6 | 5.5 |
| Solution 4 | 3 × 10−5 | 4.5 | 3 × 10−4 | 3.5 |
| Solution 5 | | | 3 × 10−5 | 4.5 |
| Solution 6 | | | 3 × 10−6 | 5.5 |
| Solution 7 | 3 × 10−6 | 5.5 | 3 × 10−4 | 3.5 |
| Solution 8 | | | 3 × 10−5 | 4.5 |
| Solution 9 | | | 3 × 10−6 | 5.5 |

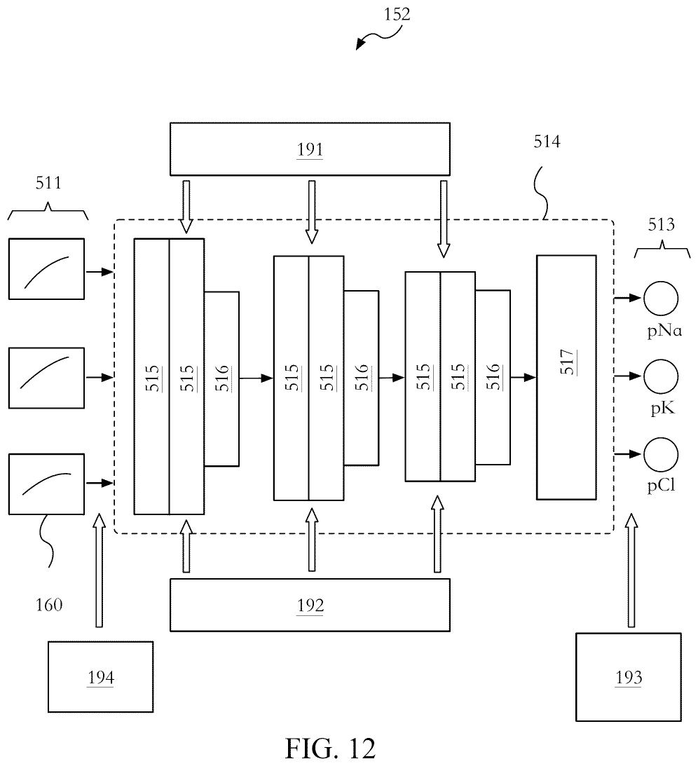

For the external electric field, reference may be made to FIG. 6A, FIG. 6B, and FIG. 6C. The drain current versus front gate voltage transfer curves 161 (I_{D}−V_{FG}) of the training solution 171 are measured respectively under the external electric fields of 0.2 V, 0.4 V, and 0.6 V. Under the same ion concentration, the target features are obtained under different biases (i.e., biasing relationships 153). Therefore, different virtual sensors 120 can obtain respective target features. Here, a CNN is used as the machine learning model 152 of the external electric field. The CNN 514 is described in an example where the input layer 511 has 3 channels, 6 convolutional layers 515, 3 maximum pooling layers 516, and 1 global average pooling layer 517, as shown in FIG. 12. In this embodiment, the convolutional layers 515 are based on a visual geometry group (VGG) network structure, and every 2 convolutional layers 515 are matched with 1 maximum pooling layer 516.

For example, there are 54 training features 160 under each V_{BG} condition. After data of 3 groups of virtual sensors 120 are channel-stacked, input signals of each sample are converted into 3-channel signals. Each channel contains 54 convolution kernels. All the neurons in each convolutional layer 515 use ReLU as the activation function. After the input signals are subjected to convolution computation by the network, each sample has 64 channel signals, and each channel contains 14 training features 160. Finally, the flattened and fully connected layer is substituted by the global average pooling layer 517, which can reduce the use of parameters, make the model lightweight and slow down the overfitting. Meanwhile, the signals are converted into 64 training features 160. In terms of the output layer 513, since all the training solutions 171 contain the chlorine ion, the output layer 513 may be set to have 3 neuron outputs, respectively representing sodium ion (pNa), potassium ion (pK) and chloride ion (pCl).

The following shows recognition results of the ion detection model 172 with unused training features 160 (i.e., features to be verified), as shown in Table 4.

TABLE 4
Statistics of results of external electric field sensing model

| | pNa | | | | pK | | | |
|---|---|---|---|---|---|---|---|---|
| | GT | Mean | MAPE | Std | GT | Mean | MAPE | Std |
| Solution 1 | 3.5 | 3.523 | 0.012 | 0.001 | 3.5 | 3.353 | 0.214 | 0.006 |
| Solution 2 | | 3.523 | 0.005 | 0.000 | 4.5 | 4.490 | 0.745 | 0.011 |
| Solution 3 | | 3.523 | 0.005 | 0.001 | 5.5 | 5.389 | 2.423 | 0.031 |
| Solution 4 | 4.5 | 4.452 | 1.567 | 0.018 | 3.5 | 3.528 | 0.140 | 0.008 |
| Solution 5 | | 4.845 | 7.121 | 0.210 | 4.5 | 4.354 | 3.742 | 0.406 |
| Solution 6 | | 4.490 | 0.733 | 0.019 | 5.5 | 5.465 | 1.057 | 0.022 |
| Solution 7 | 5.5 | 5.334 | 3.412 | 0.039 | 3.5 | 3.522 | 0.018 | 0.000 |
| Solution 8 | | 5.428 | 1.721 | 0.035 | 4.5 | 4.502 | 0.467 | 0.026 |
| Solution 9 | | 5.459 | 1.157 | 0.018 | 5.5 | 5.462 | 1.109 | 0.023 |

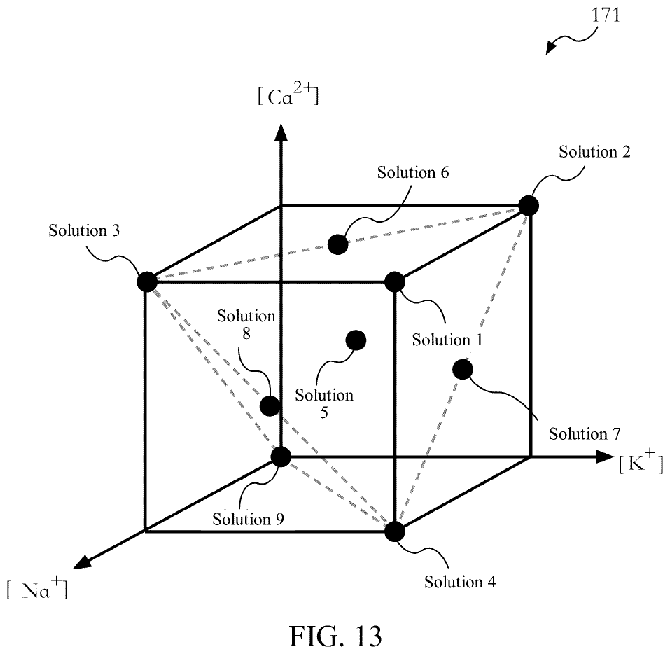

In some embodiments, when the environmental parameter 151 is the external electric field, the computer 140 may train the machine learning model 152 by using the source current two-dimensional features 163 as the training features 160. The source current two-dimensional feature 163 is a diagram including the source current 162 (I_{ds}), the front gate voltage V_{FG} and the back gate voltage V_{BG}, as shown in FIG. 7 and FIG. 13. Different dots in FIG. 13 represent training solutions 171 of different ions and concentrations. FIG. 13 shows 9 different training solutions 171. In FIG. 13, the training solutions are prepared by changing one ion concentration or maintaining only one ion concentration at a time.

In this embodiment, sodium chloride, potassium chloride, and calcium chloride (CaCl2) are dissolved in deionized water to generate mixed solutions of different concentrations of sodium ion, potassium ion and calcium ion. Sodium chloride is used to prepare training solutions 171 with sodium ion concentrations of 3×10⁻³ M, 1.5×10⁻⁵ M, and 3×10⁻⁴ M, which are respectively denoted as pNa 2.5, pNa 2.8, and pNa 3.5. Potassium chloride is used to prepare training solutions 171 with potassium ion concentrations of 3×10⁻³ M, 1.5×10⁻³ M, and 3×10⁻⁴ M, which are respectively denoted as pK 2.5, pK 2.8, and pK 3.5. Calcium chloride is used to prepare training solutions 171 with calcium ion (pCa) concentrations of 3×10⁻³ M, 1.5×10⁻³ M, and 3×10⁻⁴ M, which are respectively denoted as pCa 2.5, pCa 2.8, and pCa 3.5. The table below shows the training solutions 171 with different concentrations of ions.

TABLE 5
Compositions of mixed solutions of sodium ion, potassium ion and calcium ion

| | [Na+] M | pNa | [K+] M | pK | [Ca2+] M | pCa |
|---|---|---|---|---|---|---|
| Solution 1 | 3.049 × 10−3 | 2.516 | 2.946 × 10−3 | 2.531 | 3.199 × 10−3 | 2.495 |
| Solution 2 | 3.525 × 10−4 | 3.453 | 3.013 × 10−3 | 2.521 | 3.211 × 10−3 | 2.493 |
| Solution 3 | 2.995 × 10−3 | 2.2524 | 2.736 × 10−4 | 3.563 | 3.128 × 10−3 | 2.505 |
| Solution 4 | 3.056 × 10−3 | 2.515 | 3.066 × 10−3 | 2.513 | 3.260 × 10−4 | 3.487 |
| Solution 5 | 1.574 × 10−3 | 2.803 | 1.475 × 10−3 | 2.837 | 1.526 × 10−3 | 2.816 |
| Solution 6 | 1.411 × 10−3 | 2.841 | 1.470 × 10−3 | 2.832 | 3.147 × 10−3 | 2.502 |
| Solution 7 | 1.448 × 10−3 | 2.839 | 2.930 × 10−3 | 2.533 | 1.557 × 10−3 | 2.807 |
| Solution 8 | 2.984 × 10−3 | 2.525 | 1.473 × 10−3 | 2.831 | 1.631 × 10−3 | 2.787 |
| Solution 9 | 3.049 × 10−4 | 3.516 | 2.946 × 10−4 | 3.531 | 3.199 × 10−4 | 3.495 |

Next, the external electric field is applied to the DG-ISFET 130, as shown in FIG. 8A, FIG. 8B, and FIG. 8C. The ranges of the external electric field are as follows: the back gate voltage V_{BG} is −1 V to 1 V (corresponding to the vertical axis in FIG. 8A to FIG. 8C), and the front gate voltage V_{FG} is 0 V to 4 V (corresponding to the horizontal axis in FIG. 8A to FIG. 8C). When different back gate voltages V_{BG} are applied, the front gate voltage V_{FG} of the DG-ISFET 130 will change accordingly, so that data of features of different operation regions can be obtained. Moreover, according to the measurement results of solutions with different compositions, the source current two-dimensional feature 163 does not change sequentially with the increase of the concentration of the training solution 171. In other words, under different back gate voltages V_{BG}, ΔV_{FG}/ΔpNa, ΔV_{FG}/ΔpK, and ΔV_{FG}/ΔpCa are nonlinear variables. The electric field will have different effects on different concentrations and types of ions, and the formation of the depletion region at the bottom side of the DG-ISFET 130 makes the differences in the training features 160 more significant.

In this embodiment, in order to test the inference ability of the ion detection model 172 to unknown data, the training feature 160 of the training solution 171 numbered 5 is selected as the feature to be verified 911. The remaining training solutions 171 and the corresponding training features 160 are standardized to generate standardized training features 160. Since there may be features with low weight in the source current two-dimensional features 163, the computer 140 may perform the PCA program on selected part of the source current two-dimensional features 163 (that have been standardized) to obtain compressed features. Alternatively, the computer 140 may perform the PCA program on all of the source current two-dimensional features 163. The computer 140 finds out the principal components for training from the compressed features. The PCA program is used in a feature space to find a vector such that the data has the maximum variance after being projected onto the vector.

For example, if 289 (17*17) training features 160 are obtained from the source current two-dimensional features 163, the computer 140 performs the PCA program on the 289 training features 160 to obtain the main training features 160 and remove the redundant features, so that the cumulative variance is 99%. Therefore, after performing the PCA program, 40 main training features 160 will be obtained. The larger the variance, the better it can describe the behavior features of the data set, which are called principal components. As a result, compared with the original training features 160, the compressed features may be regarded as the training features 160 that have been reduced in dimensionality.

During the training process, 85% of the training features 160 are selected from the training solutions 171 numbered 1, 2, 3, 4, 6, 7, 8, and 9, and the selected training features 160 are used to train the machine learning model 152. The remaining 15% of the training features 160 are used to test the model and serve as a set of self-test features that do not participate in training. 30% of training features are selected from the set of training features 160 for training to verify the ion detection model 172.

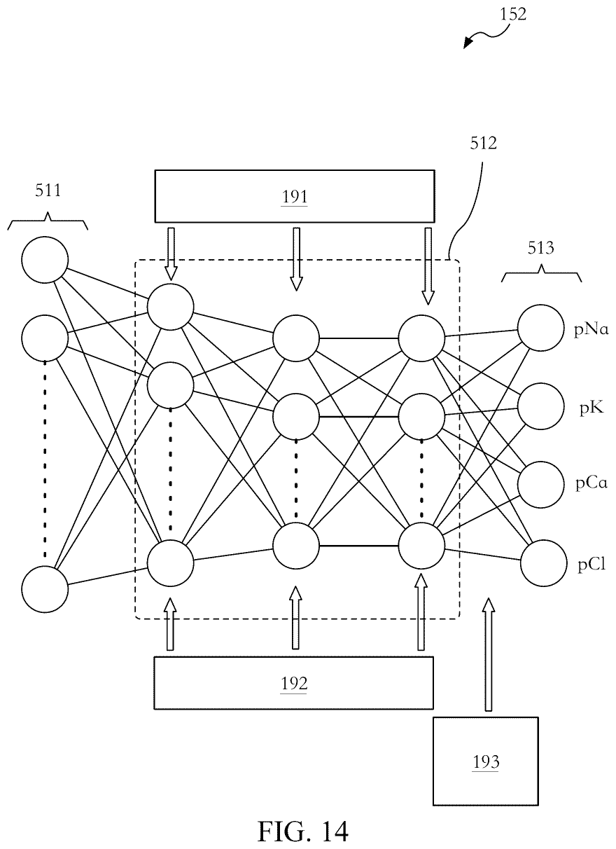

In this embodiment, the MLP is used as the machine learning model 152. The MLP has an input layer 511, 3 hidden layers 512, and an output layer 513, as shown in FIG. 14. The number of neurons in the input layer 511 is the same as that of the training features 160 that have been reduced in dimensionality. In order to realize parallel computation, the number of neurons in each hidden layer 512 is an integral of a power of 2. In this embodiment, the number of neurons in the first hidden layer 512 may be set to 256, the number of neurons in the second hidden layer 512 may be set to 128, and the number of neurons in the third hidden layer 512 may be set to 64. The neurons of each hidden layer 512 use ReLU as the activation function. Since the training solutions 171 have sodium ions, potassium ions, calcium ions, and chlorine ions, the output layer 513 has 4 neurons. For the neural network structure of the MLP, reference is made to FIG. 14. Batch normalization 191, L2 regularization 192, and random dropout of neurons 193 may be set in the MLP, thereby avoiding overfitting.

Table 6 and Table 7 below respectively show recognition results of the ion detection model 172 with unused training features 160 (i.e., features to be verified).

TABLE 6
Statistics of results of compressed signal electric field sensing model-1

| | pNa | | | | pK | | | |
|---|---|---|---|---|---|---|---|---|
| | GT | Mean | MAPE | Std | GT | Mean | MAPE | Std |
| Solution 1 | 2.516 | 2.518 | 0.097 | 0.006 | 2.531 | 2.513 | 0.690 | 0.015 |
| Solution 2 | 3.453 | 3.417 | 1.034 | 0.025 | 2.521 | 2.511 | 0.368 | 0.024 |
| Solution 3 | 2.524 | 2.527 | 0.144 | 0.001 | 3.563 | 3.549 | 0.378 | 0.022 |
| Solution 4 | 2.515 | 2.515 | 0.015 | 0.015 | 2.513 | 2.495 | 0.715 | 0.017 |
| Solution 5 | 2.803 | 2.780 | 0.833 | 0.031 | 2.837 | 2.819 | 0.631 | 0.104 |
| Solution 6 | 2.841 | 2.855 | 0.486 | 0.010 | 2.832 | 2.814 | 0.656 | 0.019 |
| Solution 7 | 2.839 | 2.835 | 0.154 | 0.016 | 2.533 | 2.532 | 0.045 | 0.018 |
| Solution 8 | 2.525 | 2.570 | 1.260 | 0.009 | 2.831 | 2.800 | 1.128 | 0.016 |
| Solution 9 | 3.516 | 3.472 | 1.238 | 0. | 3.531 | 3.462 | 1.938 | 0.020 |

TABLE 7
Statistics of results of compressed
signal electric field sensing model-2

pCa

| | GT | Mean | MAPE | Std |
|---|---|---|---|---|
| Solution 1 | 2.495 | 2.491 | 0.152 | 0.019 |
| Solution 2 | 2.493 | 2.494 | 0.021 | 0.009 |
| Solution 3 | 2.505 | 2.489 | 0.614 | 0.009 |
| Solution 4 | 3.487 | 3.462 | 0.719 | 0.006 |
| Solution 5 | 2.816 | 2.851 | 1.237 | 0.089 |
| Solution 6 | 2.502 | 2.519 | 0.659 | 0.012 |
| Solution 7 | 2.807 | 2.808 | 0.013 | 0.005 |
| Solution 8 | 2.787 | 2.791 | 0.176 | 0.009 |
| Solution 9 | 3.495 | 3.455 | 1.143 | 0.015 |

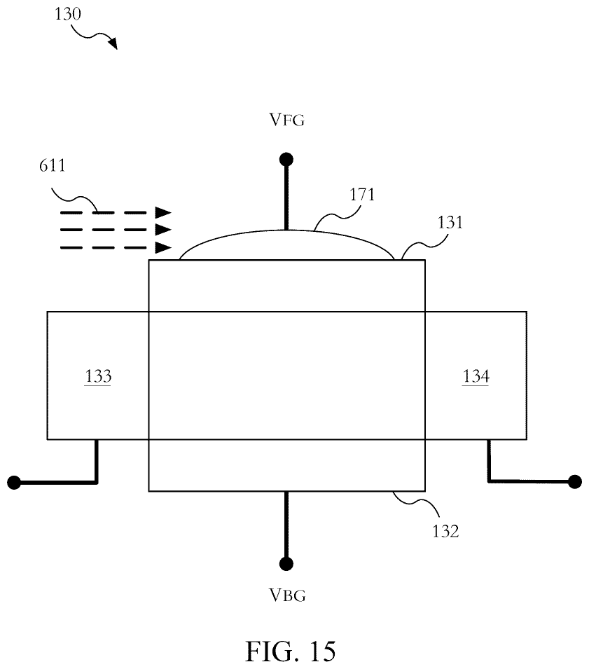

In some embodiments, the system 100 may also apply external magnetic fields 611 of different intensities to the training solution 171 to obtain the training features 160 under different external magnetic fields 611. Referring to FIG. 15, the training solution 171 is configured in the front gate pin 131 of the DG-ISFET 130, and the external magnetic field 611 (indicated by dashed arrows) is applied to the training solution 171. The computer 140 drives the controller 110 and adjusts the corresponding external magnetic field 611 (i.e., the environmental parameter 151). The computer 140 obtains the training features 160 corresponding to the external magnetic fields 611 by means of the virtual sensors 120.

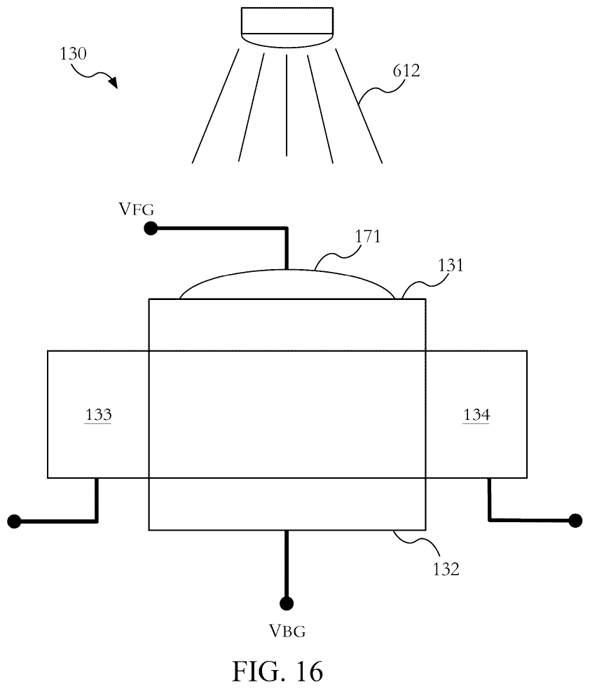

In some embodiments, the system 100 may also apply light of different intensities to the training solution 171 to obtain the training features 160 under different light intensities. Referring to FIG. 16, the training solution 171 is configured in the front gate pin 131 of the DG-ISFET 130, and the light intensity 612 is applied above the training solution 171. In addition, the computer 140 may also adjust the wavelength, frequency and energy of light to generate different light intensities 612.

The method and system for establishing a model for detecting ions in a solution, and the method and system for sensing ions in a solution can realize a larger number of virtual sensors 120 by means of a limited number of physical sensors 120. Since there is no need to generate an ion-selective membrane on the sensor 120, the volume of the physical sensors 120 can be effectively reduced and the sensors 120 can be applied to wearable devices or Internet of Things devices. Moreover, the sensors 120 do not need other additional devices, so the overall cost can be effectively controlled. In addition, the virtual sensors 120 obtain various recognition features of the solution to be tested 921 (or training solution 171) under different solution temperatures, bias combinations, or other environmental conditions. The system 900 for sensing ions in a solution can effectively recognize various ion types and ion concentrations in a solution of multiples ions.

What is claimed is:

1. A method for establishing a model for sensing ions in a solution, applying an ion-sensitive field-effect transistor (ISFET) in machine learning for ion detection in a training solution, the method comprising:
establishing at least one virtual sensor based on a biasing relationship of the ISFET;
adjusting an environmental parameter;
obtaining, by the at least one virtual sensor, a plurality of training features of the training solution based on the environmental parameter and a bias parameter, the biasing relationship comprising a plurality of bias parameters; and
loading, by a computer, the environmental parameter and the training features into a machine learning model to establish an ion detection model, the ion detection model being used to sense an ion type and an ion concentration.

2. The method for establishing a model for sensing ions in a solution according to claim 1, wherein the ISFET is any one of a dual gate ISFET, a fin FET, a nanowire FET, or a silicon-on-insulator FET.

3. The method for establishing a model for sensing ions in a solution according to claim 1, wherein the environmental parameter is selected from any one of a plurality of target temperatures, any one of a plurality of external electric fields (V_{BG}), any one of a plurality of external magnetic fields, or any one of a plurality of light intensities.

4. The method for establishing a model for sensing ions in a solution according to claim 1, wherein the machine learning model comprises a multilayer perceptron (MLP), a convolutional neural network (CNN), or a combination thereof.

5. The method for establishing a model for sensing ions in a solution according to claim 3, wherein the training features are a drain current versus front gate voltage transfer curve (I_{D}−V_{FG}), a source current, a source current two-dimensional feature, or a combination thereof.

6. The method for establishing a model for sensing ions in a solution according to claim 5, wherein after the step of adjusting an environmental parameter, the method comprises:
selecting one of the remaining target temperatures, the selected target temperature being a new environmental parameter;
obtaining, by the ISFET, the corresponding drain current versus front gate voltage transfer curve based on the new environmental parameter; and
repeatedly selecting the target temperatures until all the target temperatures are completed.

7. The method for establishing a model for sensing ions in a solution according to claim 5, wherein after the step of adjusting an environmental parameter, the method comprises:
selecting one of the remaining external electric fields, the selected external electric field being a new environmental parameter;
obtaining, by the ISFET, the corresponding drain current versus front gate voltage transfer curve based on the new environmental parameter; and
repeatedly selecting the external electric fields until all the external electric fields are completed.

8. The method for establishing a model for sensing ions in a solution according to claim 5, wherein after the step of adjusting an environmental parameter, the method comprises:
selecting one of the remaining external electric fields, the selected external electric field being a new environmental parameter;
obtaining, by the ISFET, the corresponding source current two-dimensional feature based on the new environmental parameter; and
repeatedly selecting the external electric fields until all the external electric fields are completed.

9. The method for establishing a model for sensing ions in a solution according to claim 8, wherein the step of loading, by a computer, the environmental parameter and the training features into a machine learning model to establish an ion detection model comprises:
selecting, by the computer, part of the source current two-dimensional features, and carrying out a principal component analysis (PCA) on the selected source current two-dimensional features to obtain a compressed feature; and
loading, by the computer, the compressed feature and the environmental parameters into the machine learning model, and establishing the ion detection model.

10. The method for establishing a model for sensing ions in a solution according to claim 5, wherein after the step of adjusting an environmental parameter, the method comprises:
selecting one of the remaining external magnetic fields, the selected external magnetic field being a new environmental parameter;
obtaining, by the ISFET, the corresponding drain current versus front gate voltage transfer curve based on the new environmental parameter; and
repeatedly selecting the external magnetic fields until all the external magnetic fields are completed.

11. The method for establishing a model for sensing ions in a solution according to claim 1, wherein after the step of obtaining, by the at least one virtual sensor, a plurality of training features of the training solution based on the environmental parameter, the method comprises:
standardizing, by the computer, the training features to generate standardized training features.

12. A method for sensing ions in a solution, using an ion-sensitive field-effect transistor (ISFET) to sense an ion type and an ion concentration of a solution to be tested, the method comprising:
configuring the solution to be tested at the ISFET;
driving, by the ISFET, a back gate pin of the ISFET based on a bias parameter to generate a virtual sensor;
obtaining, by the virtual sensor, a feature to be verified corresponding to the solution to be tested; and
receiving, by a computer, the feature to be verified, and loading the feature to be verified into an ion detection model to obtain the ion type and the ion concentration of the solution to be tested.

13. The method for sensing ions in a solution according to claim 12, wherein the step of configuring the solution to be tested at the ISFET comprises:
configuring the solution to be tested at a front gate pin of the ISFET.

14. The method for sensing ions in a solution according to claim 12, wherein the feature to be verified comprises a drain current versus front gate voltage transfer curve (I_{D}−V_{FG}), a source current, a source current two-dimensional feature, or a combination thereof of the ISFET.

15. A system for establishing a model for sensing ions in a solution, applied in machine learning for ion detection in at least one training solution, the system comprising:
a controller, configured to adjust an environmental parameter;
a virtual sensor, configured in the training solution, the virtual sensor obtaining a plurality of training features of the training solution based on the environmental parameter; and
a computer, connected to the controller and the virtual sensor, the computer having a machine learning model, the computer loading the training features into the machine learning model to establish an ion detection model, and the ion detection model sensing an ion type and an ion concentration of each of the training solutions.

16. The system for establishing a model for sensing ions in a solution according to claim 15, wherein the environmental parameter is selected from any one of a plurality of target temperatures, any one of a plurality of external electric fields (V_{BG}), any one of a plurality of external magnetic fields, or any one of a plurality of light intensities.

17. The system for establishing a model for sensing ions in a solution according to claim 15, wherein the virtual sensor is established based on a biasing relationship of an ion-sensitive field-effect transistor (ISFET).

18. The system for establishing a model for sensing ions in a solution according to claim 15, wherein the training features are a drain current versus front gate voltage transfer curve (I_{D}−V_{FG}), a source current, a source current two-dimensional feature, or a combination thereof.

19. The system for establishing a model for sensing ions in a solution according to claim 18, wherein the computer has a principal component analysis program, the computer selects part of the source current two-dimensional features and carries out the principal component analysis program on the selected source current two-dimensional features to obtain a compressed feature, and the computer loads the compressed feature and the environmental parameter into the machine learning model and establishes the ion detection model.

20. A system for sensing ions in a solution, configured to sense a plurality of ion types and an ion concentration of a solution to be tested, the system comprising:
a sensor, comprising:
a first transmission interface, configured to transmit a feature to be verified; and
an ion-sensitive field-effect transistor (ISFET), electrically connected to the first transmission interface, the solution to be tested being configured at a gate pin of the ISFET, and the ISFET driving the gate pin based on a bias parameter to obtain the feature to be verified corresponding to the solution to be tested; and
a computer, comprising
a storage unit, configured to store an ion detection model;
a second transmission interface, connected to the first transmission interface through signals and configured to transmit the feature to be verified; and
a processing unit, electrically connected to the storage unit and the second transmission interface, the processing unit loading the feature to be verified into the ion detection model to obtain the ion types and the ion concentration of the solution to be tested.

21. The system for sensing ions in a solution according to claim 20, wherein the ISFET is any one of a dual gate ISFET, a fin FET, a nanowire FET, or a silicon-on-insulator FET.

22. The system for sensing ions in a solution according to claim 20, wherein the solution to be tested is configured at a front gate pin of the ISFET.

23. The system for sensing ions in a solution according to claim 20, wherein the feature to be verified comprises a drain current versus front gate voltage transfer curve (I_{D}−V_{FG}), a source current, a source current two-dimensional feature, or a combination thereof of the ISFET.
